(19) United States
(12) Patent Application Publication
(10) Pub. No.: US 2009/0103975 A1
(43) Pub. Date: Apr. 23, 2009

(54) Attaching element

(76) Inventor: Predrag Todorovic, Berlin (DE)

Correspondence Address: Harbin Klima Law Group PLLC, 500 Ninth Street SE, Washington, DC, 20003, US

(21) Appl. No.: 12/289,043

(22) Filed: Oct. 20, 2008

(30) Foreign Application Priority Data
Oct. 19, 2007 (DE) 10 2007 050 159.7

(51) Int. Cl. F16B 5/06

(52) U.S. Cl. 403/226

(57) ABSTRACT

An attaching element for the connection of two components 1, 2 ensures the connection of the components 1, 2 with a predefined possibility for movement relative to each other. The attaching element includes two legs 3, 4 essentially parallel to each other, which are connected by an elastic connecting portion 5 integrally formed with the legs 3, 4, with the elastic connecting portion 5 having a partly circular cross-section in side view.

This application claims priority to German Patent Application DE102007050159.7 filed Oct. 19, 2007, the entirety of which is incorporated by reference herein.

The present invention relates to an attaching element for connecting two components.

More particularly, the present invention relates to an attaching element by which two components are attachable to each other such that the components can perform a defined movement relative to each other. A typical example here is the connection of two concentric components allowed to perform slight radial and axial movement relative to each other to compensate for heat expansion, for example.

In the state of the art, attaching elements are known, which provide for both the desired movability and a defined location by suitable selection of materials (elastic bushes or similar) or by design measures (oblong holes, openings with larger diameters for guide pins with smaller diameters).

It is here disadvantageous that the designs known from the state of the art involve high manufacturing and assembly effort and include many individual items. The complexity of the design incurs considerable wear which may result in slack and chatter and considerably reduces service-life of the attaching element in general.

In a broad aspect, the present invention provides for an attaching element of the type specified at the beginning above, which ensures a precise location of the components relative to each other, while avoiding the disadvantages of the state of the art and combining ease of design with simple, cost-effective producibility.

The present invention accordingly provides a one-piece design of an attaching element which has two, preferably plate-type or strip-type legs which are generally parallel to each other and operationally connected via an elastic element which is integrally connected to the legs. The two legs serve for attachment to the two components to be connected, with each of the components to be connected to one of the legs. Preferably, the design is selected such that a first attaching part, which is connectable to one of the components, essentially rectangularly protrudes from one of the legs, i.e., extends at a generally 90° angle relative to a plane of the leg. The other leg preferably has an extension and is provided at its side with a second attaching part which is connectable to the other component.

Thus, the attaching element in accordance with the present invention provides for precise concentric and axial positioning of two components, while ensuring limited, defined relative movability in several directions of movement.

The present invention accordingly provides a single, one-piece attaching element which is cost-effectively producible and requires only minimum effort for its assembly.

The attaching element according to the present invention is here designed such that the moment of inertia is minimum in that direction of loading in which relative movement preferably occurs. Moreover, provision is made that the stiffness of the attaching element is maximum in the direction of loading in which no, or only minimum, relative movement is permitted.

Application of the attaching element according to the present invention therefore allows radial and circumferential movement between two components to be connected, with the attaching element according to the present invention being subject to a bending stress only. In the other direction, in which movement is essentially to be avoided, a maximum degree of stiffness is provided.

The present invention is more fully described in light of the accompanying drawings showing a preferred embodiment. In the drawings,

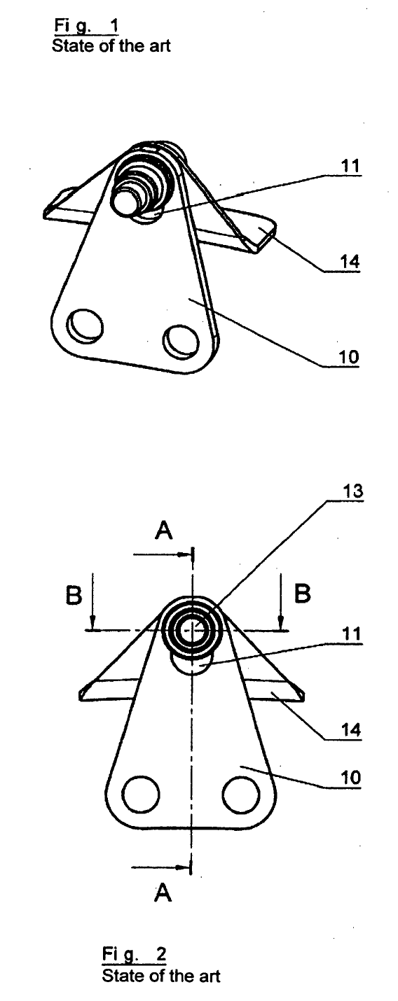

FIG. 1 is a perspective view of an attaching element according to the state of the art,

FIG. 2 is a side view of the attaching element shown in FIG. 1,

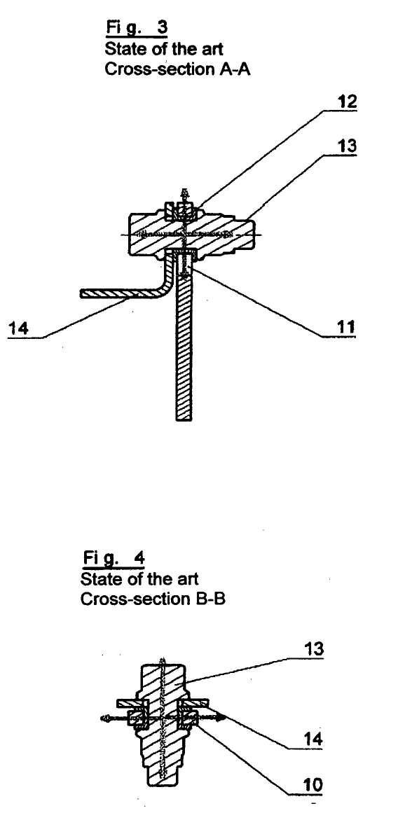

FIG. 3 is a sectional view along line A-A of FIG. 2,

FIG. 4 is a sectional view along line B-B of FIG. 2,

FIG. 5 is a perspective view, analogically to FIG. 1,

FIG. 6 is a simplified representation showing the application of the attaching element known from the state of the art for the connection of two components,

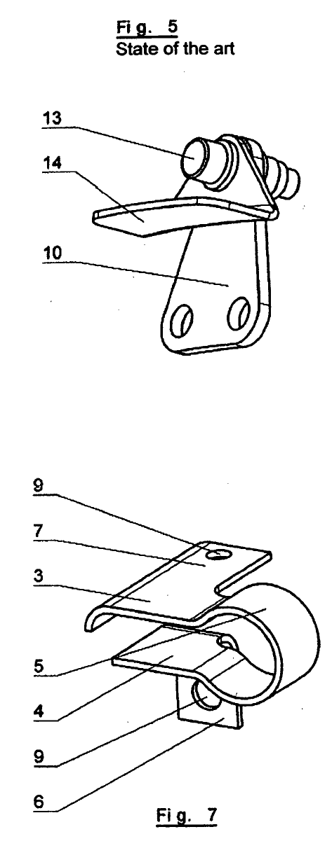

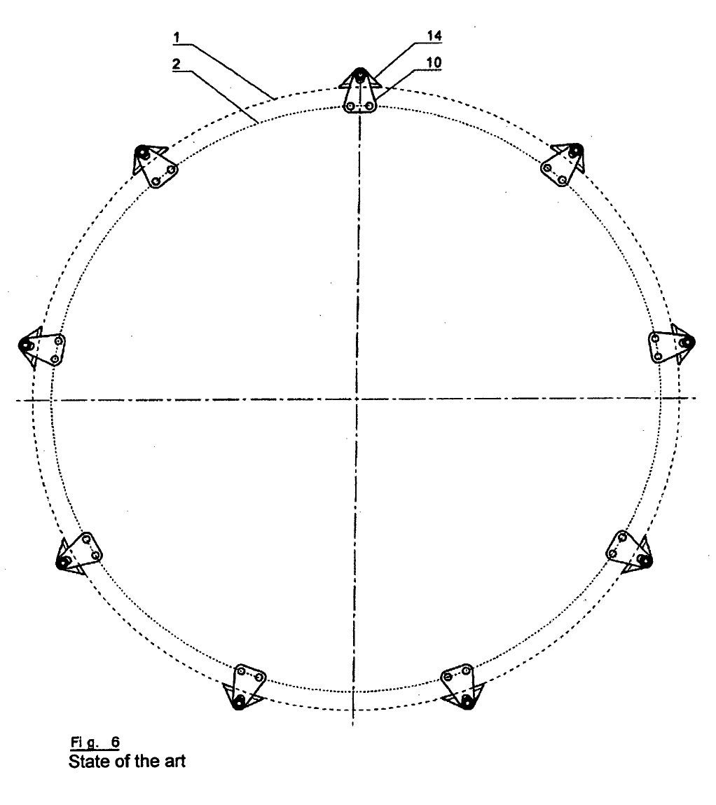

FIG. 7 is a perspective view of an attaching element according to the present invention,

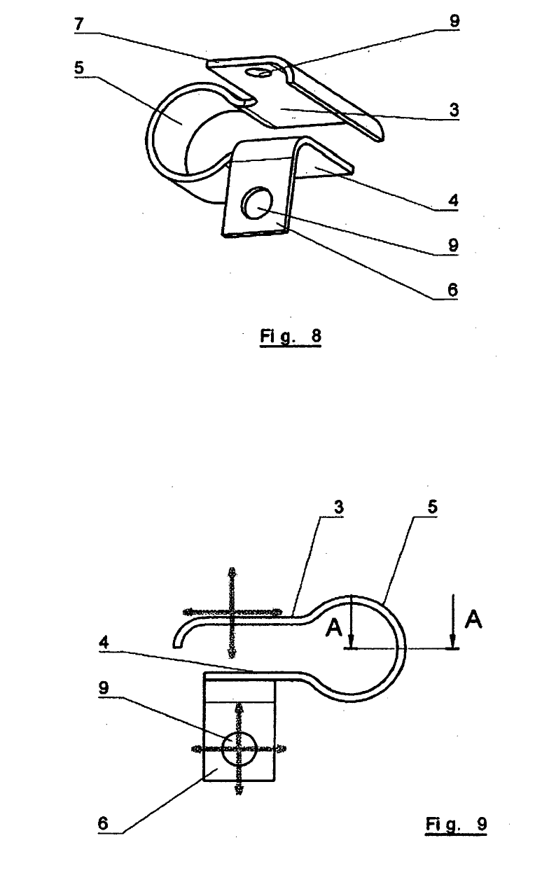

FIG. 8 is a further perspective view of the attaching element shown in FIG. 7,

FIG. 9 is a side view of the attaching element of FIGS. 7 and 8,

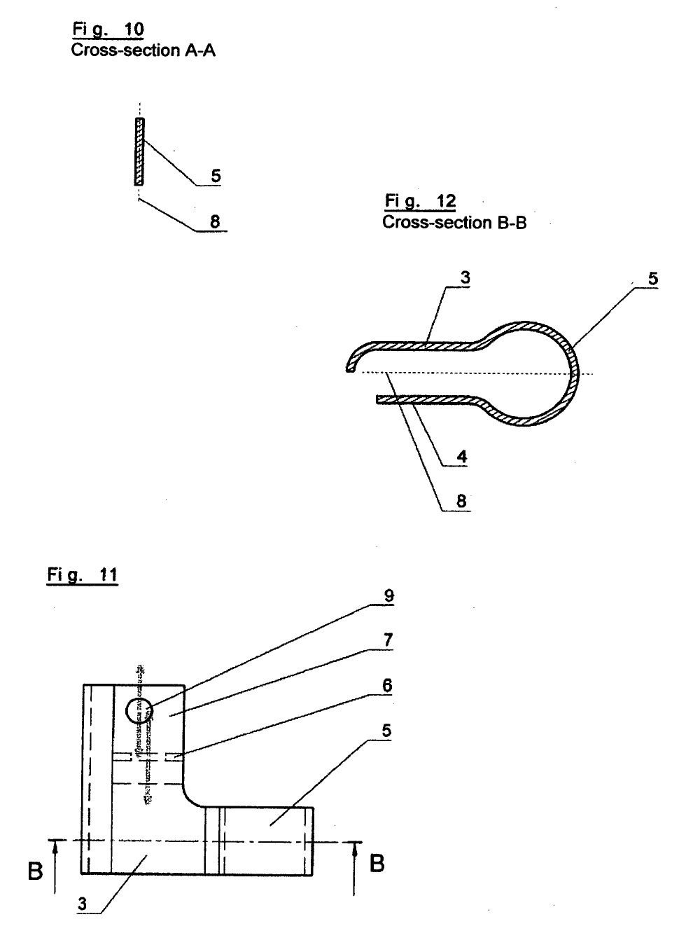

FIG. 10 is a sectional view along line A-A of FIG. 9,

FIG. 11 is a top view of the attaching element of FIGS. 7 to 9,

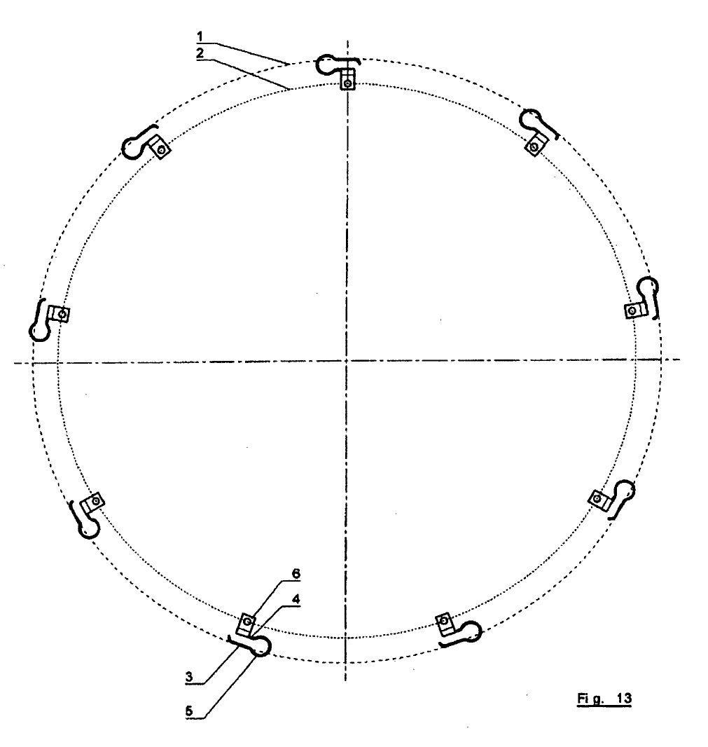

FIG. 12 is a sectional view along line B-B of FIG. 11, and

FIG. 13 is a view, analogically to FIG. 6 of an example for using the attaching element in accordance with the present invention.

The state of the art (Prior Art) shows typical attaching elements for the connection of two components 1, 2 (see FIG. 6) arranged concentrically to each other. Here, a bearing plate 10 is provided which has an opening 11 in which a guide ring 12 with a U-shaped cross-section is disposed. The guide ring 12 is passed by a bearing pin 13 which locates a second bearing plate 14. The representations in FIGS. 3 and 4 show three-dimensional movability between the first bearing plate 10 and the second bearing plate 14. The representations further indicate the general complexity and expensiveness of the overall design.

FIGS. 7 and 8 show an example of the attaching element according to the present invention. The attaching element includes a first leg 3 and, generally parallel to and spaced from it, a second leg 4, which legs 3, 4 are each connected (see FIG. 9, in particular) to an elastic connecting portion 5. The elastic connecting portion 5, which is integrally connected to the two legs 3, 4, has a circular cross-section and accordingly, is partly cylindrical (see FIGS. 7 and 8).

Extending essentially rectangularly (at a generally 90° angle) from the second leg 4 is a first attaching part 6 which is provided with an opening and is fixable to a component, for example, the component 2 (see FIG. 13), by a threaded connection.

The first leg 3 has a sideward extension and includes a second attaching part 7 which is also provided with an attaching opening to be threadedly connected to the component 1 (FIG. 13).

FIGS. 9 and 11 each show the directions of movement in three dimensions. In the case of the direction of movement according to FIG. 11, torsion or shear of the elastic part 5 will occur. As this is relatively resistant against this type of deformation, only minimum movement is all in all possible.

“Softer” location is, however, possible in the case of a relative movement along the vertical arrows according to FIG. 9 since only a very small cross-section (see FIG. 10) is subject to bending stress. The broken line indicates an elastically neutral line (FIG. 10).

FIG. 12 is a side view showing the partly circular cross-section of the elastic connecting portion 5 which, in connection with the cross-section shown in FIG. 10, results in the aforementioned elastic properties. In one embodiment, the elastic connecting portion 5 has a diameter greater than an effective length of each leg.

Also in the case of a deformation in accordance with the horizontal arrows in FIG. 9, the elastic connecting portion 5 is subject to a bending stress enabling a “softer” location of the components with respect to each other, i.e., easier relative movement between the components.

Thus, radial and circumferential movements of the components 1 and 2 are easily possible since the attaching element according to the present invention is, via the cross-section A-A (FIG. 10), only subject to bending stresses involving a minimum moment of inertia of the cross-section. This allows larger relative movements to be performed. The axial location entails shear deformation or torsion of the cylindrical elastic connecting portion 5, this resulting in a “harder” location of the components with respect to each other than with the cross-section A-A (FIG. 10), i.e., firmer relative movement between the components.

Summarizing then, the attaching element according to the present invention is characterized by simplicity of construction and ease of design which is precisely pre-definable via suitable dimensioning and material selection. Since wear is very low compared with the state of the art, a considerable increase in service-life is obtained. The reduced assembly effort and the small number of parts result in significant cost saving. A further advantage is a reduction in weight using the inventive attaching element.

### LIST OF REFERENCE NUMERALS

1 Component
2 Component
3 First leg
4 Second leg
5 Elastic connecting portion
6 First attaching part
7 Second attaching part
8 Elastically neutral line
9 Attaching opening
10 First bearing plate
11 Opening
12 Guide ring
13 Bearing pin
14 Second bearing plate

What is claimed is:

1. An attaching element for connecting two components to be movable relative to each other, comprising:
two legs extending generally parallel to each other, each leg being attachable to a respective one of the two components; and
an elastic connecting portion integrally formed with the legs and connecting the legs together, the elastic connecting portion having a partly circular cross-section in side view.

2. The attaching element of claim 1, wherein one of the legs includes a first attaching part that extends from the leg at a generally 90° angle with respect to a plane of the leg.

3. The attaching element of claim 2, wherein the legs are at least partly formed as planar plates.

4. The attaching element of claim 3, wherein the first attaching part has a plate-type form.

5. The attaching element of claim 4, wherein the other leg includes a lateral extension and a second attaching part.

6. The attaching element of claim 5, wherein the elastic connecting portion has a diameter greater than an effective length of each leg.

7. The attaching element of claim 6, wherein the first attaching part includes an attaching opening for receiving an attachment fastener.

8. The attaching element of claim 7, wherein the second attaching part includes an attaching opening for receiving an attachment fastener.

9. The attaching element of claim 8, wherein the attaching element is configured as a one-piece bending plate.

10. The attaching element of claim 9, wherein the attaching element provides for a softer relative movement between the two components in one direction and a firmer relative movement between the two components in another direction.

11. The attaching element of claim 1, wherein the legs are at least partly formed as planar plates.

12. The attaching element of claim 2, wherein the first attaching part has a plate-type form.

13. The attaching element of claim 2, wherein the other leg includes a lateral extension and a second attaching part.

14. The attaching element of claim 1, wherein the elastic connecting portion has a diameter greater than an effective length of each leg.

15. The attaching element of claim 2, wherein the first attaching part includes an attaching opening for receiving an attachment fastener.

16. The attaching element of claim 5, wherein the second attaching part includes an attaching opening for receiving an attachment fastener.

17. The attaching element of claim 1, wherein the attaching element is configured as a one-piece bending plate.

18. The attaching element of claim 1, wherein the attaching element provides for a softer relative movement between the two components in a first direction and a firmer relative movement between the two components in a second direction.

19. The attaching element of claim 18, wherein the elastic connecting portion is more elastic in the first direction than in the second direction.
